(19) United States
(12) Patent Application Publication
(10) Pub. No.: US 2017/0197460 A1
(43) Pub. Date: Jul. 13, 2017

(54) AUXILIARY DRIVE MECHANISM FOR MOTOR VEHICLE

(71) Applicant: Yaqoub Yousef Hussain Alyousefi, Kuwait (KW)

(72) Inventor: Yaqoub Yousef Hussain Alyousefi, Kuwait (KW)

(21) Appl. No.: 14/989,981

(22) Filed: Jan. 7, 2016

(51) Int. Cl. B60B 15/10

(52) U.S. Cl. CPC B60B 15/10

(57) ABSTRACT

An auxiliary drive mechanism for moving a motor vehicle through mud, sand or snow includes an axle, one or two central hubs perpendicular to the axle and parallel with a pair of drive wheels for rotation about the axle. The mechanism also includes four to six outwardly extendable arms fixed to the central hub and rotatable therewith as well as a plurality of arc-shaped drive members with one of the drive members fixed to each of the outwardly extendable arms. Each of the outwardly extendable arms further includes a piston and a mass of hydraulic fluid for extending the arms outward beyond the diameter of a vehicle's drive wheels and tires. The mechanism further includes a mechanism for increasing a flow of hydraulic fluid to the pistons.

### FIELD OF THE INVENTION

This invention relates to an auxiliary drive mechanism and more particularly to a retractable hydraulic drive mechanism for a motor vehicle in mud, sand or snow.

### BACKGROUND FOR THE INVENTION

Auxiliary drive mechanisms for motor vehicles have been known for many years for coping with mud, sand and snow. For example, a U.S. Pat. No. 2,283,948 of Ridgway discloses an automobile tractor device wherein a moveable carrier is adapted to be swung into and out of an operative position. The carrier has a plurality of traction chains to be swung underneath a motor vehicle tire.

A retractable traction and antiskid device for motor vehicles is disclosed in a U.S. Pat. No. 2,747,691 of Lakey et al. As disclosed, a device includes a rotary head for carrying traction elements wherein the traction elements that are formed of resilient shape retaining material that are adapted to be mounted on the vehicle as rotary units. In a modified arrangement the rotary unit incorporates a multiplicity of separable and preferably deformable shape retrainng traction elements that can be individually removed and replaced.

Further a U.S. Pat. No. 3,711,116 of Campbell discloses an anti-skid attachment for automobiles in which a ground engaging anti-skid wheel is driven through a gear box from a power engaging wheel with the anti-skid attachment movable into and out of operation by a hydraulically actuated cylinder. The anti-skid attachment may be attached and detached by hand without the use of tools.

Finally, two traction devices of Smith are disclosed in U.S. Pat. Nos. 7,360,778 and 8,376,380. The traction device for a motor vehicle provides a rear support assembly positioned proximate to a rear axle and an adjacent portion of a leaf spring and a front rocker support assembly. The front rocker support assembly includes a front leaf spring bracket supply attached to the front leaf spring, a pivot stop extending across the upper surface of the leaf spring at a predetermined distance rearward from the leaf spring eye for engaging an upper surface of the leaf spring to limit pivotal movement of the front rocker support assembly relative to the front end of the leave spring and a rocker pivotally attached to the front leaf spring bracket assembly. An adjustable rigid link extends between the rear support assembly and the front rocker support assembly.

Notwithstanding the above, it is presently believed that there is a need and a potential commercial market for an auxiliary drive mechanism for a motor vehicle with improved traction for use in mud, sand and snow.

### SUMMARY OF THE INVENTION

In essence, a retractable hydraulic drive mechanism for movement of a motor vehicle having a pair of drive wheels for mud, sand and snow. The mechanism comprises and/or consists of:

An axle, a central hub perpendicular to the axle and parallel with a pair of drive wheels of the motor vehicle for rotation about the axle as well as an independent drive mechanism for rotating the central hub assembly about the axle.

The mechanism also includes and/or consists of a plurality of four (4) to six (6) or more radially extending outwardly extendable arms fixed to the central hub and rotatable therewith independently of the normal drive wheels as well as a plurality of arc-shaped drive members with one of the drive members fixed to each of the outwardly extendable arms.

Each of the outwardly extendable arms include a piston and a mass of hydraulic fluid for extending said arms outwardly together with the drive members and independently controlled by a driver.

In addition, the mechanism includes a further means for increasing the flow of hydraulic fluid to the pistons to thereby extend the extendable arms and arc-shaped drive members beyond the diameter of the drive wheels and tires.

In a preferred embodiment of the invention, a pair of such mechanisms are included with one on each side of the vehicle. In a further embodiment of the invention, each of the drive members includes a source of compressed air while the drive member on an outer surface includes an inflatable member as for example in the shape of a tractor tire.

The invention will now be described in connection with the accompanying drawings wherein like reference numerals have been used to designate like parts.

### DESCRIPTION OF THE DRAWINGS

FIG. 1 is a schematic illustration of a retractable hydraulic drive mechanism for moving a motor vehicle through mud, sand or snow;

FIG. 2 is a schematic illustration of a second embodiment of the invention;

FIG. 3 is a schematic illustration of a motor vehicle rear axle assembly with a retractable hydraulic drive mechanism in accordance with the invention installed next to one or both of a vehicle's drive wheels;

FIG. 4 is a schematic illustration of a rear axle of a conventional truck with a pair of dual drive wheels on each side of the truck;

FIG. 5 is a schematic illustration of a rear axle of a truck in accordance with one embodiment of the present invention; and

FIG. 6 is a schematic plan view of a front and rear axle assembly in accordance with a further embodiment of the invention wherein the vehicle is a front wheel drive vehicle with an expandable auxiliary drive mechanism activatable through a rear axle.

### DESCRIPTION OF THE PREFERRED EMBODIMENT OF THE INVENTION

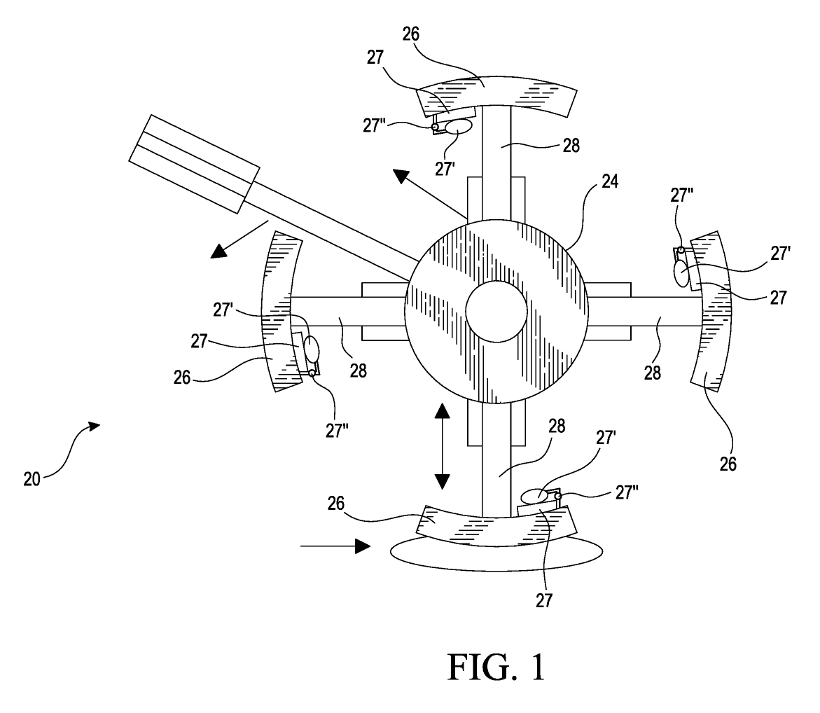

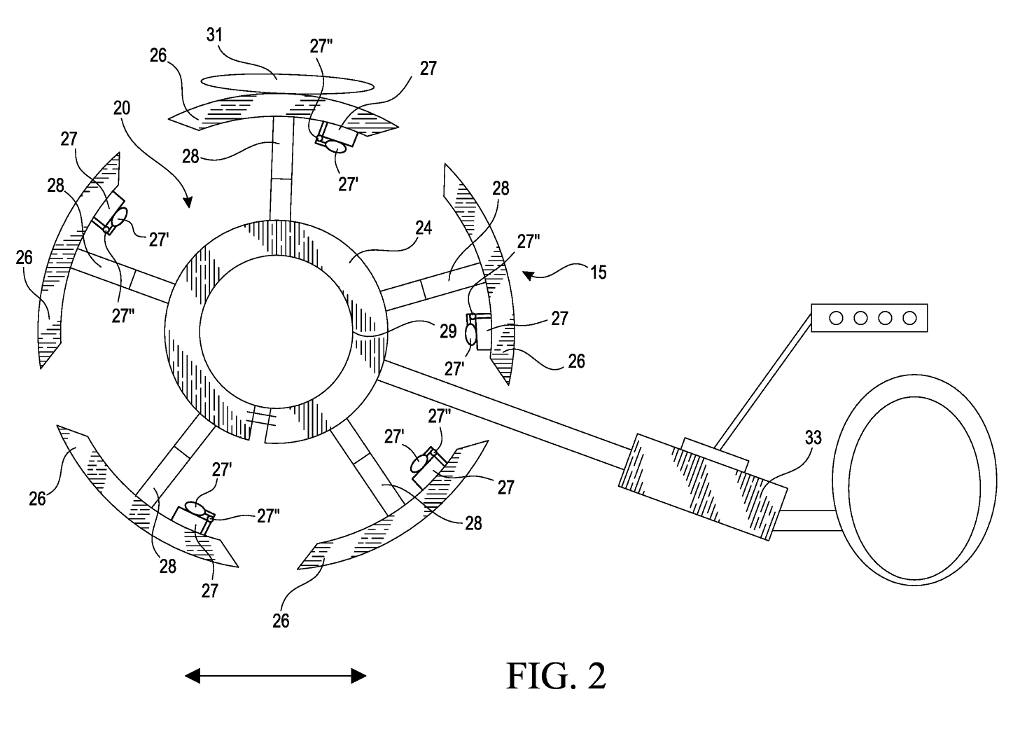

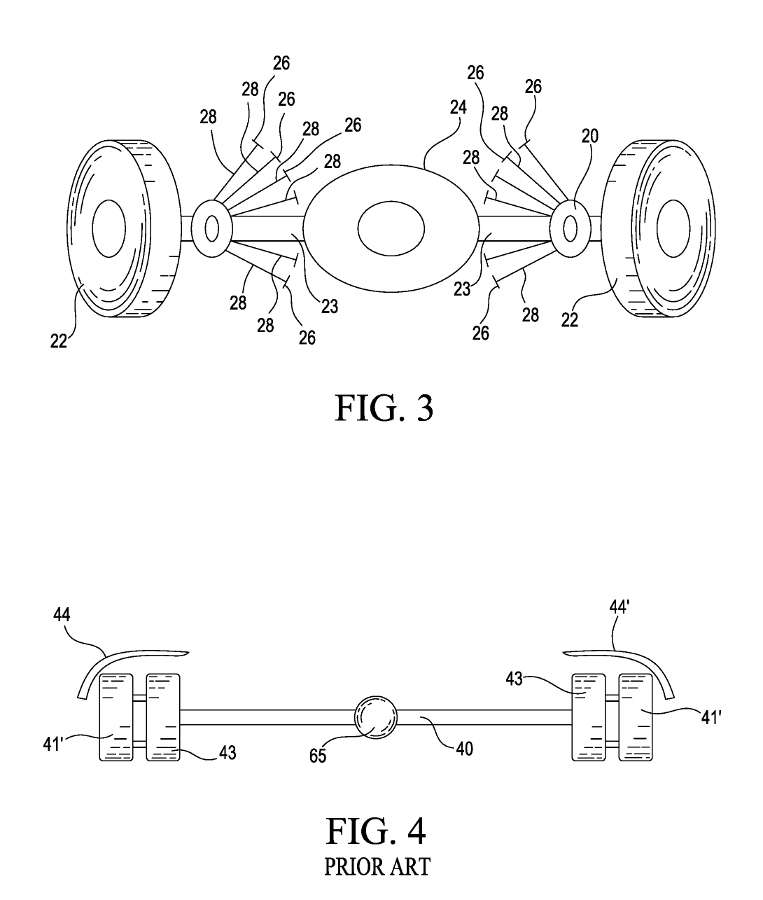

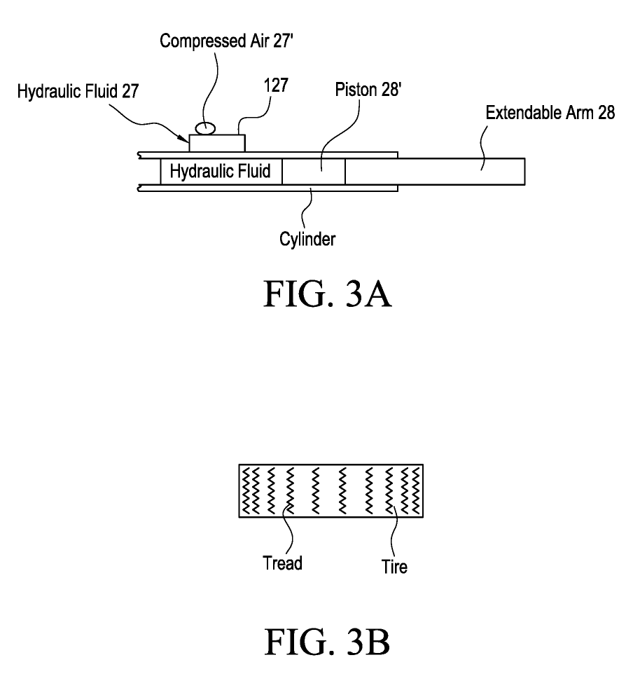

As illustrated in FIGS. 1-3, an auxiliary retractable hydraulic drive mechanism 20 for the movement of a motor vehicle having a pair of conventional drive wheels 22 in mud, sand and snow includes a rear axle assembly 24. It is also contemplated to provide a separate axle assembly forward or aft of a standard rear axle for driving the segmented auxiliary drive members 26 of the vehicle. A separate auxiliary drive mechanism is incorporated for rotating the auxiliary drive members 26 and rotating a plurality of segmented arc-shaped drive members 26 independently as directed by a driver through a control 33 for an auxiliary drive mechanism as shown schematically in FIG. 3.

In the preferred embodiment of the invention the auxiliary retractable hydraulic drive mechanism 20 utilizes a conventional rear axle to rotate the drive wheels 22 as well as the auxiliary mechanism 20. The conventional rear axle assembly is modified to drive the wheels or the auxiliary segmented drive members independently of one another. The mechanism for independently driving the drive wheels 22 and the auxiliary drive members 26 will be described in a latter part of the specification. The conventional rear axle assembly is modified to drive the drive wheels or the auxiliary segmented drive members independently of one another. The mechanism for independently driving the drive wheels and the auxiliary drive members may be similar to that used for putting a vehicle in four-wheel drive but will be described in a latter part of the specification.

As illustrated, the auxiliary member 20 includes an axle 23 and a central hub 24 that is perpendicular to the axle 23 and configures to rotate the central hub 24 around the axle 22. A drive mechanism such as the output of the motor vehicle engine provides the power and output for rotating the central hub 24 in a conventional manner as will be well understood by a person of ordinary skill in the art.

The auxiliary drive mechanism also includes a plurality of extendable arms 28. The auxiliary drive mechanism 20 also includes the plurality of outwardly extendable arms 28 preferably four to six extendable arms 28 that are extended by one or more pistons and a mass of hydraulic fluid. As illustrated, a single source of hydraulic fluid 29 may be used to expand the arms 28 or a plurality of four to six arms can be expanded by four to six individual supplies in a conventional manner as will be fully understood by a person of ordinary skill in the art.

A plurality of arc-shaped drive members 26 are fixed to the ends of the arms 28 and expanded outwardly to provide a segmented circle with a larger diameter than the diameter of the drive wheels 22 and tires of the vehicle. The arc-shaped drive members in a first embodiment of the invention include an aggressive rubber snow and mud grip tire tread as for example used on tractors. However, in a preferred embodiment of the invention each of the drive members includes a source of compressed air 27 and an expandable extension 31 to enhance movement through the mud and snow.

In an alternative embodiment the drive mechanism includes a separate or independent axle forward or behind the vehicle's drive train. In this embodiment the vehicle engine rotates a drive shaft through an auxiliary power output with an opposite end connected to a solid axle i.e. without a differential.

As illustrated in FIG. 4, a conventional rear axle 40 for a truck includes dual drive wheels 41 and 43 on each side of the truck and driven by the common axle 40 through a differential 44. One particular truck model in this country relates to a pick-up truck with two pair of drive wheels and enlarged fenders 44 for protection against mud, snow, ice, gravel and the like.

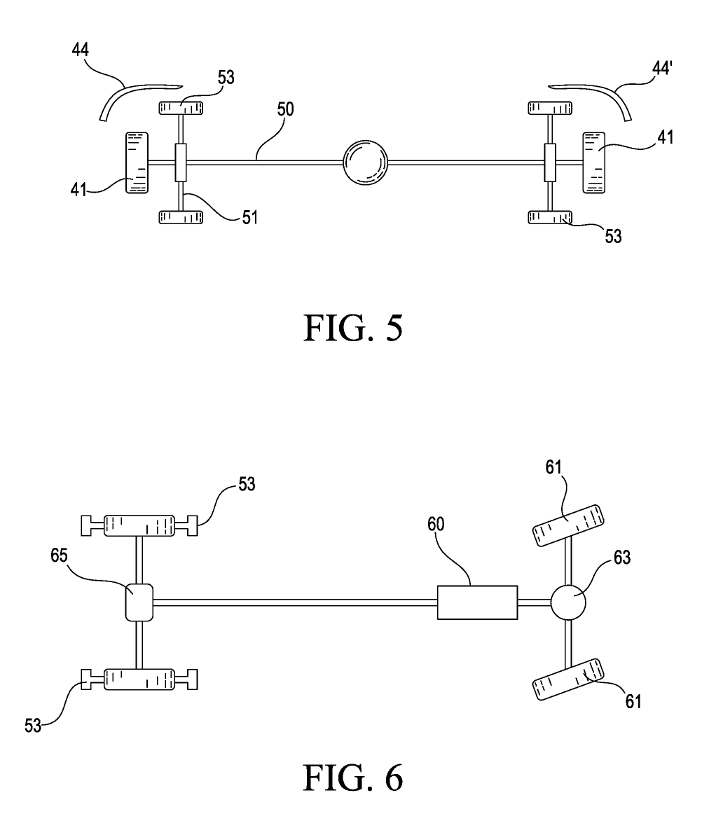

An embodiment as shown in FIGS. 3 and 5 is generally similar to the conventional axle in that the outer drive wheels 41 and expandable drive members 51 are rotatable about a single axle 50. In this embodiment, the fenders 44 will need to accommodate the larger diameter of the expandable rotatable arms 51 and drive members 53.

A still further embodiment of the invention is illustrated in FIG. 6 wherein a conventional front wheel drive wheels 61 are driven by an engine 60 and gears 63. A separate drive assembly or power take-off is shown connected to an output of the engine and is engaged with a rear auxiliary drive mechanism 65 for rotating the expandable drum member 53. The drive mechanism is engageable in essentially the same manner as a mechanical shifter for four-wheel drive vehicles as will be well understood by a person of ordinary skill in the art. Further, it is contemplated that the shift for the auxiliary drive mechanism will engage a slow speed gearing mechanism only and at the same time will preferably disengage the drive connected to the normal drive wheels of the vehicle.

While the invention has been described in connection with its preferred embodiments, it should be recognized and understood that changes and modifications may be made therein without departing from the scope of the appended claims.

1-2 (canceled)

3. A retractable hydraulic drive mechanism for the movement of a motor vehicle having a pair of drive wheels in mud, sand and snow according to claim 1, in which said mechanism includes six (6) outwardly extending arms.

4. A retractable hydraulic drive mechanism for the movement of a motor vehicle having a pair of drive wheels in mud, sand and snow, said mechanism consisting of:
an axle, a central hub and the retractable hydraulic drive mechanism perpendicular to the axle and parallel with the drive wheels of the motor vehicle for rotation about the axle;
a plurality of outwardly extendable arms fixed to said central hub and rotatable therewith, and a plurality of arc-shaped drive members with one of said drive members fixed to each of said outwardly extendable arms; and
each of said outwardly extendable arms including a piston and a mass of hydraulic fluid for extending said arms outwardly; and
means for increasing the supply of hydraulic fluid to said pistons to thereby extend said arc-shaped drive members beyond the diameter of the vehicle's wheels and tires;
in which said mechanism includes four (4) outwardly extending arms; and
in which each of said arc-shaped drive members includes an aggressive mud and snow tread; and
each of said arc-shaped drive members are spaced apart and include a source of compressed air and an expandable extension of said drive member by compressed air.

5. A retractable hydraulic drive mechanism for the movement of a motor vehicle having a pair of drive wheels in mud, sand and snow according to claim 3, in which each of said arc-shaped drive members are spaced apart and include a source of compressed air and an expandable extension of said drive member by compressed air.

6. A retractable hydraulic drive mechanism for the movement of a motor vehicle having a pair of drive wheels in mud, sand and snow according to claim 3, in which said rotatable central hub is adaptably rotated by an auxiliary drive mechanism in the motor vehicle at a relatively slow speed independently of said vehicle's normal drive wheels as independently controlled by a driver.

7. A retractable hydraulic drive mechanism for the movement of a motor vehicle having a pair of drive wheels in mud, sand and snow, said mechanism consisting of:
an axle, a central hub perpendicular to said axle and parallel with the drive wheels of the motor vehicle for rotation about said axle an a drive mechanism for rotating said central hub assembly about said axle;
a plurality of outwardly extendable arms fixed to said central hub and rotatable therewith and a plurality of arc-shaped drive members with one of said drive members fixed to each of said outwardly extendable arms; and
each of said outwardly extendable arms including a piston and a mass of hydraulic fluid for extending said arms outwardly; and
means for increasing the supply of hydraulic fluid to said pistons to thereby extend said arc-shaped drive members beyond the diameter of the vehicle's wheels and tires.

8. An auxiliary hydraulic drive mechanism for the movement of a motor vehicle in mud, sand or snow, said mechanism comprising:
an axle and a pair of central hubs perpendicular to said axle for rotation about said axle and with one of said central hubs on each end of said axle;
a drive mechanism for rotating said pair of central hubs about said axle;
a plurality of outwardly extendable arms fixed to each of said central hubs and rotatable therewith in a plurality of arc-shaped drive members with one of said drive members fixed to an outer end of each of said outwardly extendable arms;
each of said outwardly extendable arms including a piston and a mass of hydraulic fluid for extending said arms outwardly; and
means for increasing the supply of hydraulic fluid or pressurizing the hydraulic fluid to thereby extend said arms and said arc-shaped drive members outwardly beyond the diameter of the vehicle's drive wheels.

9. The auxiliary hydraulic drive mechanism for the movement of a motor vehicle in mud, sand or snow accordingly to claim 8, in which each of said central hubs includes four outwardly extendable arms and wherein each outwardly extendable arm includes one arc-shaped drive member.

10. The auxiliary hydraulic drive mechanism for the movement of a motor vehicle in mud, sand or snow accordingly to claim 8, in which each of said central hubs includes six outwardly extendable arms and wherein each outwardly extendable arm includes one arc-shaped drive member.

11. The auxiliary hydraulic drive mechanism for the movement of a motor vehicle in mud, sand or snow accordingly to claim 8, in which each of said arc-shaped drive members are spaced apart and include a source of compressed air and an expandable extension of said drive member by said compressed air.

12. The auxiliary hydraulic drive mechanism for the movement of a motor vehicle in mud, sand or snow, said mechanism consisting of:
an axle and a pair of central hubs perpendicular to said axle for rotation about said axle and with one of said central hubs on each end of said axle;
a drive mechanism for rotating said pair of central hubs about said axle;
a plurality of outwardly extendable arms fixed to each of said central hubs and rotatable therewith in a plurality of arc-shaped drive members with one of said drive members fixed to an outer end of each of said outwardly extendable arms;
each of said outwardly extendable arms including a piston and a mass of hydraulic fluid for extending said arms outwardly; and
means for increasing the supply of hydraulic fluid or pressurizing the hydraulic fluid to thereby extend said arms and said arc-shaped drive members outwardly beyond the diameter of the vehicle's drive wheels.
